(19) United States
(12) Patent Application Publication
(10) Pub. No.: US 2026/0054487 A1
(43) Pub. Date: Feb. 26, 2026

(54) RECORDING APPARATUS AND CONTROL METHOD FOR RECORDING APPARATUS

(71) Applicant: CANON KABUSHIKI KAISHA, Tokyo (JP)

(72) Inventors: KENTARO MURO, Tokyo (JP); SATOSHI AZUMA, Tokyo (JP); YOSHIAKI MURAYAMA, Tokyo (JP); JUN YASUTANI, Kanagawa (JP); SEIJI SUZUKI, Kanagawa (JP); TAKUTO MORIGUCHI, Kanagawa (JP); OSAMU YOSHITAKE, Chiba (JP); RAN KUDO, Tokyo (JP)

(21) Appl. No.: 19/302,484

(22) Filed: Aug. 18, 2025

(30) Foreign Application Priority Data
Aug. 23, 2024 (JP) 2024-141944
Apr. 15, 2025 (JP) 2025-066891

(51) Int. Cl. B41J 2/17; B41J 2/165; B41J 2/175

(52) U.S. Cl. CPC B41J 2/1728; B41J 2/16523; B41J 2/17566; B41J 2002/17569

(57) ABSTRACT

The present disclosure includes: a recording head to eject ink; a storage tank to store the ink to be supplied to the recording head; a first flow path through which the ink flows from the storage tank to the recording head; a second flow path through which the ink from the recording head flows; a discharge flow path branched from a circulation flow path including the first and second flow paths and through which the ink is circulated; a waste liquid tank to store liquid discharged from the circulation flow path through the discharge flow path; a discharge unit to discharge the ink from the circulation flow path to the waste liquid tank; and a control unit to control recording by the recording head and discharge by the discharge unit. The control unit causes the discharge unit to perform the discharge during the recording of the recording head.

### BACKGROUND

### Field of the Technology

The present disclosure relates to a recording apparatus, and a control method for a recording apparatus.

### Description of the Related Art

If a recording head that ejects liquid such as ink is left in a state not ejecting liquid for a long period of time, volatile components in the liquid evaporate from ejection ports, which causes the liquid to become concentrated and increases the concentration of solid components such as pigments. In a case where the concentration of solid components in the liquid becomes high, the viscosity increases, which may cause defective ejection. Japanese Patent Laid-Open No. 2018-8513 describes a technique for discharging a liquid from a recording head in a case where it is estimated that the concentration has become high.

In the method of Patent Literature 1, there has been a problem that downtime of the apparatus occurs, where printing cannot be started or continued due to the execution of the discharge operation from the head.

### SUMMARY

An object of the present disclosure is to provide a recording apparatus capable of suppressing downtime due to ink discharge, so as to perform stable recording.

A recording apparatus according to an embodiment of the present disclosure includes: a recording head configured to eject ink; a storage tank configured to store the ink to be supplied to the recording head; a first flow path through which the ink flows from the storage tank to the recording head; a second flow path through which the ink coming out of the recording head flows; a discharge flow path branched from a circulation flow path, which is configured with the first flow path and the second flow path and through which the ink is circulated; a waste liquid tank configured to store liquid discharged from the circulation flow path through the discharge flow path; a discharge unit configured to discharge the ink from the circulation flow path to the waste liquid tank; and a control unit configured to control a recording operation performed by the recording head and a discharge operation performed by the discharge unit, wherein the control unit causes the discharge unit to perform the discharge operation during the recording operation of the recording head.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic view of a recording apparatus;

FIG. 2 is a plan view of a conveyance unit of the recording apparatus;

FIGS. 3A and 3B are explanatory diagrams illustrating the configuration of a recording head and the configuration of heater boards;

FIG. 4 is a cross-sectional view of the recording head;

FIG. 5 is an explanatory diagram of a circulation unit;

FIG. 6 is a diagram illustrating an ink flow path in the recording head;

FIG. 7 is an explanatory diagram illustrating the height of the recording head during recording;

FIG. 8 is an explanatory diagram of capping of the recording head;

FIG. 9 is a block diagram of a control unit of the recording apparatus;

FIG. 10 is a flowchart illustrating an example of processing executed by the control unit;

FIGS. 11A to 11C are diagrams illustrating an example of data used in processing;

FIGS. 12A and 12B are flowcharts illustrating an example of processing executed by the control unit, and an evaporation speed table;

FIG. 13 is a flowchart illustrating an example of processing executed by the control unit;

FIG. 14 is a flowchart illustrating an example of processing executed by the control unit;

FIG. 15 is a flowchart illustrating an example of processing executed by the control unit;

FIG. 16 is an explanatory diagram of a circulation unit;

FIG. 17 is a flowchart illustrating an example of processing executed by the control unit;

FIG. 18 is a flowchart illustrating an example of processing executed by the control unit;

FIG. 19 is an explanatory diagram of a circulation unit;

FIG. 20 is a schematic diagram of a serial type recording apparatus;

FIGS. 21A to 21C are explanatory diagrams of a circulation unit;

FIGS. 22A and 22B are explanatory diagrams of a cleaning unit; and

FIG. 23 is an explanatory diagram of the configuration of flow paths.

### DESCRIPTION OF THE EMBODIMENTS

Hereinafter, a description is given about an inkjet recording apparatus according to embodiments of the present disclosure.

### First Embodiment

### Configuration of the Recording Apparatus

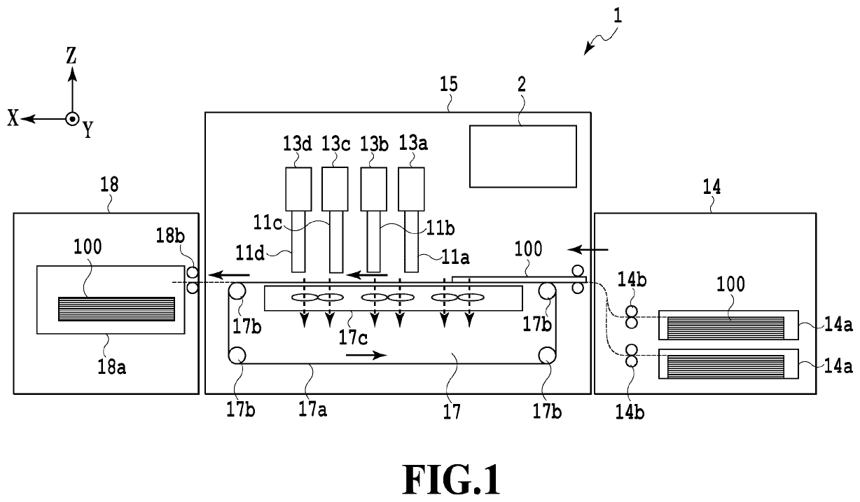

FIG. 1 is a schematic diagram of the recording apparatus 1 according to the present embodiment. The recording apparatus 1 is an apparatus that records an image by ejecting ink, which is liquid, onto the recording media 100. In the drawing, the arrows X, Y, and Z indicate directions intersecting with one another, and the X direction and Y direction are horizontal directions orthogonal to each other. The Z direction is the vertical direction. In the case of the present embodiment, the X direction, Y direction, and Z direction indicate the overall length direction, depth direction, and height direction of the recording apparatus 1, respectively.

Note that “recording” refers not only to a case where meaningful information such as characters and figures is formed, but also to a broader case where meaningful or meaningless images, designs, patterns, or the like are formed on a recording medium, or where the medium is processed, regardless of whether or not the recorded result is perceivable to human vision. Further, although sheet-like paper is assumed as the “recording medium” in the present embodiment, a cloth, a plastic film, or the like may also be used.

The recording apparatus 1 includes the feeding device 14, the image forming device 15, and the collecting device 18. The feeding device 14 is a device that feeds the recording media 100 to the image forming device 15. The feeding device 14 includes the stacking portions 14a on each of which a plurality of recording media 100 before recording is stacked, and the conveyance mechanisms 14b. In the case of the present embodiment, a plurality of stacking portions 14a is installed. Further, the conveyance mechanism 14b is installed for each of the stacking portions 14a. The conveyance mechanisms 14b each include a pair of rollers that nip and convey the recording media 100.

The collecting device 18 is a device that collects the recording media 100 after recording, which are discharged from the image forming device 15. The collecting device 18 includes the stacking portion 18a on which a plurality of recording media 100, which is a plurality of recorded products, is stacked, and the conveyance mechanism 18b. The conveyance mechanism 18b includes a pair of rollers that nip and convey the recording media 100.

The image forming device 15 includes the conveyance unit 17 that conveys the recording media 100 in the X direction, the plurality of recording heads 11a to 11d that ejects liquid onto the recording media 100, and the elevating/lowering units 13a to 13d that elevate and lower the recording heads 11a to 11d. In a case where the recording heads 11a to 11d are collectively referred to or are not distinguished from one another, they are simply referred to as the recording heads 11. Similarly, in a case where the elevating/lowering units 13a to 13d are collectively referred to or are not distinguished from one another, they are simply referred to as the elevating/lowering units 13. The control unit 2 controls the entire recording apparatus.

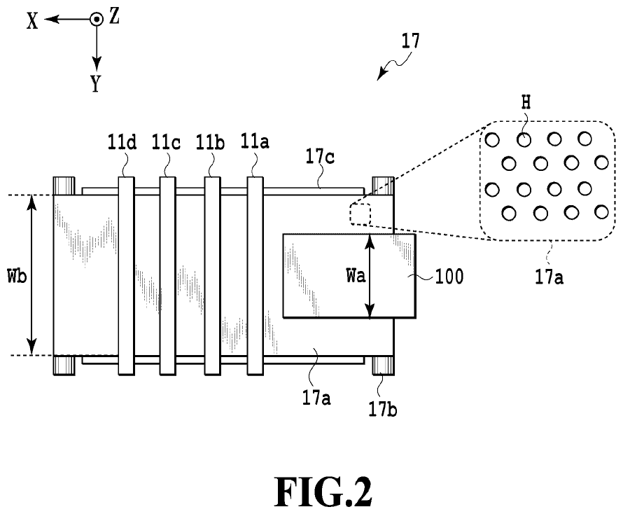

FIG. 2 is a plan view of the conveyance unit 17. The present drawing is a diagram illustrating the conveyance unit as viewed in the Z direction toward the −Z direction. The conveyance unit 17 is an example of a movement mechanism that moves the recording heads 11 and the recording medium 100 relative to each other, and in this case, the relative movement between them is performed by moving the recording medium 100 relative to the stationary recording heads 11. The conveyance unit 17 includes the endless conveyance belt 17a, a plurality of rollers 17b that cause the conveyance belt 17a to run, and the suctioning device 17c. The plurality of rollers 17b is caused to rotate around an axis extending in the Y direction by a driving source (e.g., a motor), which is not illustrated in the drawings. Due to the rotation of the plurality of rollers 17b, the conveyance belt 17a runs in a circulatory manner in a counterclockwise direction as viewed in FIG. 1.

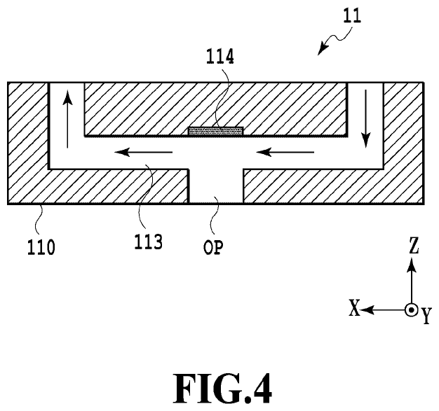

Examples of the material of the conveyance belt 17a include resin and metal. The conveyance belt 17a is a conveyance medium for the recording medium 100, and runs in the X direction with the recording medium 100 placed thereon in a part of its running section (which is referred to as a conveyance section or a recording section). The conveyance belt 17a faces the lower surface of the recording heads 11 (the later-described ejection port surface 110 illustrated in FIG. 4, etc.) in the conveyance section.

The conveyance belt 17a has a large number of holes H formed therein at a predetermined pitch. The suctioning device 17c includes, for example, an electric fan, and is located below the conveyance belt 17a in the conveyance section, so as to generate an airflow from above toward downstream in the Z direction. By the action of the suctioning device 17c, air is suctioned through the number of holes H in the conveyance belt 17a in the conveyance section. Accordingly, the recording medium 100 is conveyed while being attracted toward the conveyance belt 17a in the conveyance section, thereby making it possible to stabilize the conveyance behavior of the recording medium 100. The air pressure for the suctioning can be set to −500 Pa, for example. The conveyance speed can be set to 0.5 m/s, for example.

Note that, although the conveyance with attraction utilizing air suctioning is employed as the conveyance form of the recording medium 100 in the present embodiment, it is also possible to employ conveyance with attraction utilizing suctioning by static electricity. Alternatively, roller-based conveyance in which a recording medium is directly nipped and conveyed by multiple pairs of rollers may also be employed. The conveyance unit 17 may additionally include a unit that has a function of drying or cooling the recording medium 100, etc.

### Recording Head

The recording heads 11 are recording heads that perform recording by ejecting ink onto the recording medium 100. The recording heads 11 are full-line type heads extending in the width direction (the Y direction) of the recording medium 100, and have liquid ejection ports aligned over a range covering the width of the recording medium 100 of the maximum size that can be used. FIG. 2 exemplifies the width Wa of the medium-sized recording medium 100. The effective length of the ejection port arrays of the recording heads 11 (for example, 368 mm) is accommodated within the width Wb (for example, 380 mm) of the conveyance belt 17a.

The recording heads 11a to 11d are arranged from the upstream side to the downstream side in the conveyance direction of the recording medium 100. The recording heads 11a to 11d eject different types of ink. For example, the recording heads 11a to 11d eject four types of ink, i.e., yellow ink, magenta ink, cyan ink, and black ink, in that order. Note that the types and number of inks, and the ejection order in the conveyance direction of the recording medium 100 (the arrangement order of the recording heads 11a to 11d) are not limited to this example.

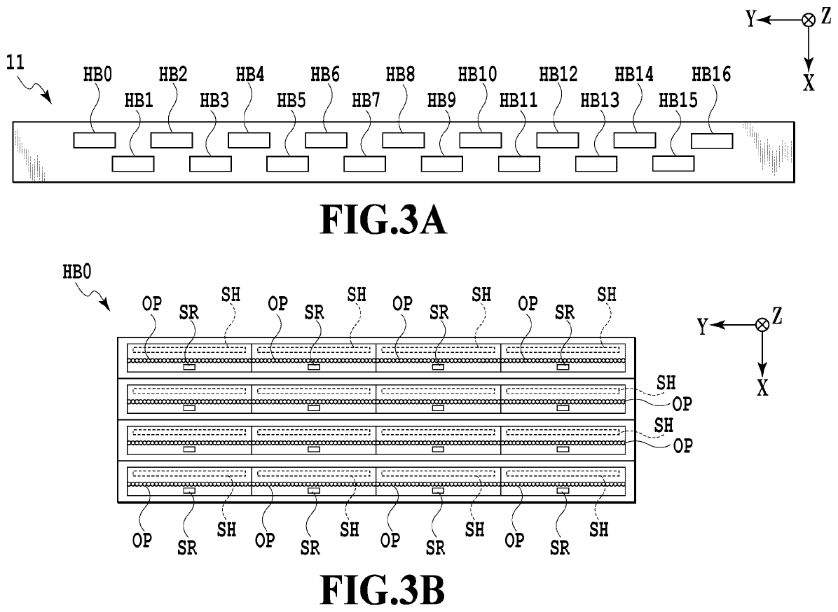

Next, a description is given about the configuration of the recording heads 11. FIGS. 3A and 3B are diagrams illustrating a recording head and heater boards. FIG. 3A is an explanatory diagram illustrating the configuration of the recording heads 11, and FIG. 3B is an explanatory diagram of the heater boards. As illustrated in FIG. 3A, the recording heads 11 are each equipped with, for example, the 17 heater boards (the recording element substrates) HB0 to HB16. FIG. 3B illustrates an example of the configuration of the heater board HB0, and the other heater boards HB1 to HB16 have the same configuration.

The heater board HB0 has ejection port arrays in each of which a plurality of ejection ports OP is aligned in the Y direction. The ejection port arrays are formed as a plurality of arrays (four arrays in FIG. 3B) apart from each other in the X direction. Further, the heater board HB0 is also equipped with the temperature sensors SR and the sub-heaters SH which are heating elements. Upon an application of a voltage to the sub-heaters SH, the sub-heaters SH generate heat to heat up the substrate of the heater board HB0, and the heated substrate heats up the ink in the vicinity of the substrate. By adjusting the ink temperature in advance using the sub-heaters SH, the ink can be ejected efficiently at the time of ink ejection. The heater board HB0 is divided into 16 (4×4) sections, and each section is equipped with one sub-heater SH. This makes it possible to heat up the heater board HB0 on a per section basis.

The temperature sensors SR are sensors for detecting the temperature of the heater board HB0. In the present embodiment, the ink temperature can be set to a desired temperature by controlling the application of a driving pulse to the sub-heaters SH based on the temperatures detected by the temperature sensors SR during and before recording.

As illustrated in FIG. 3A, the heater boards HB0 to HB16 are arranged in a staggered manner such that the end portions of the ejection port arrays of adjacent heater boards overlap with each other in the X direction. The lower surface of each recording head 11 is formed as the ejection port surface 110 on which ejection port arrays are formed as such. Note that the recording heads 11 do not have to be configured with the plurality of heater boards HB0 to HB16, and may be configured with a single heater board with a long ejection port array extending in the Y direction.

FIG. 4 is a cross-sectional view of the periphery of one ejection port OP. The ejection port OP communicates with the individual flow path 113, which is formed for each ejection port OP, and the individual flow path 113 is equipped with the recording element 114, which is installed for each ejection port OP. This recording element 114 is, for example, an electro-thermal conversion element, which generates thermal energy by an application of a driving pulse. The generated thermal energy causes the ink to generate bubbles, thereby ejecting the ink from the corresponding ejection port OP. Note that, as the recording element 114, a piezoelectric element, an electrostatic element, or a MEMS element may also be used instead of an electrothermal conversion element.

In the individual flow path 113, ink flows in the direction indicated by the arrows in FIG. 4. In the present embodiment, the ink is supplied to the recording heads 11 in a circulatory manner.

### Circulation Flow Path, Discharge Flow Path

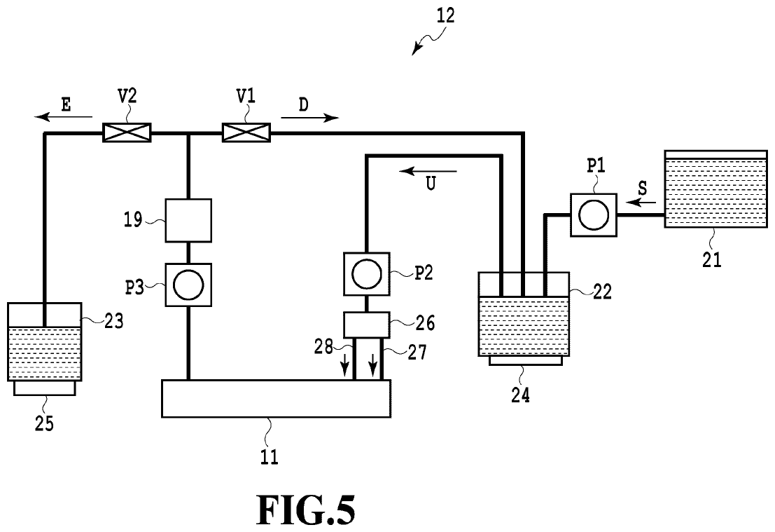

FIG. 5 is an explanatory diagram of the circulation unit 12 that circulates ink. The recording apparatus 1 includes the ink tank 21, the storage tank 22, and the circulation unit 12 for each of the heads 11. The ink tank 21 and the storage tank 22 are liquid containers that contain the ink to be ejected by the corresponding recording head 11. For example, the ink tank 21a and the storage tank 22a corresponding to the recording head 11a contain black ink. The configuration is such that the recording head 11 and the storage tank 22 are connected via flow paths, and the ink is circulated by a pump installed between them. The waste liquid tank 23 is a tank for containing the ink that has become waste liquid in the circulation flow path. The waste liquid tank may be common to all colors, but in a case of using a reaction liquid, it is preferable that the reaction liquid and the inks are separated from each other.

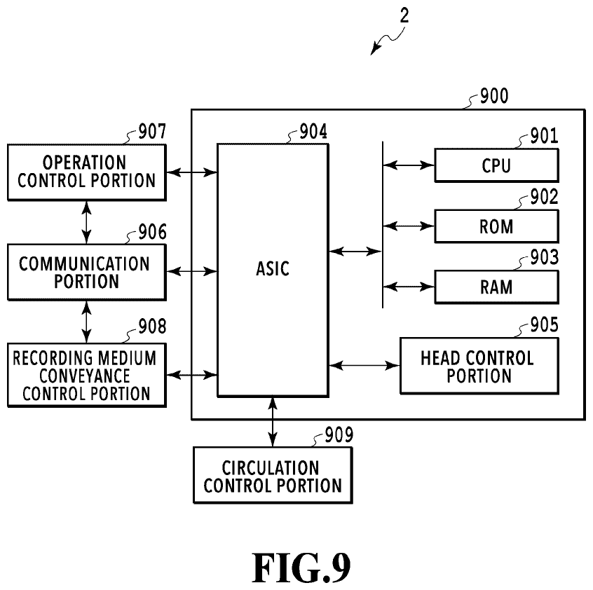

Hereinafter, with the storage tank 22 and the recording head 11 as the boundaries, the portion where ink flows from the storage tank 22 to the recording head 11 is referred to as the upstream flow path (the flow path flowing in the direction of the arrow U), and the portion where ink flows from the recording head 11 to the storage tank 22 is referred to as the downstream flow path (the flow path flowing in the direction of the arrow D). The pump P2 is connected in the upstream flow path. In the downstream flow path, the pump P3 is connected, and the flow meter 19 capable of measuring the fluid volume of ink per unit time is connected downstream of the pump P3. The circulation control portion 909 (see FIG. 9) obtains the flow rate measured by the flow meter 19 and controls the rotation speed of the pumps P2 and P3. As illustrated in FIG. 5, the storage tank 22 and the waste liquid tank 23 include an ink residual quantity detection mechanism equipped with the sensor 24 and the sensor 25 that each measures weight to detect the ink residual quantity.

Upon the driving of the pump P1 in FIG. 5, ink is supplied from the ink tank 21 to the storage tank 22. Ink supply begins in a case where the ink residual quantity in the storage tank becomes low (for example, in a case where the residual quantity falls to 1000 g out of the upper limit 2000 g). If ink has been supplied up to a predetermined weight (for example, 2000 g), the ink supply is stopped. In a case where the ink residual quantity in the storage tank 22 becomes low (for example, in a case where the residual quantity falls to 1000 g), ink is supplied again.

In the downstream flow path, a branching flow passage is formed, and one path of the branch is connected to the flow path returning to the storage tank 22 and the other path is connected to the flow path heading to the waste liquid tank 23. The valves V1 and V2, which are electrically openable, are connected to the two branched flow paths, respectively. In a case where ink discharge is not performed, the valve V1 is opened and the valve V2 is closed. Further, in a case where ink discharge is performed, the valve V2 is opened and then the valve V1 is closed. The ink discharge amount is controlled by measuring the change in weight using the ink residual quantity detection mechanism of the waste liquid tank 23. Here, the discharge amount can also be controlled by measuring the amount of weight loss in the storage tank. If the discharge amount reaches a predetermined amount after the valve V2 is opened, the valve V1 is opened and the valve V2 is closed to complete the discharge operation. By performing switching with the valves, advantages can be expected in that the discharge amount can be easily controlled, and that the discharge operation can also be executed by the pump used for the circulation operation without adding another pump, thereby reducing cost.

Further, since the branching flow passage is formed downstream of the flow meter 19 (the flow meter 19 is installed on the recording head 11 side relative to the branching flow passage), the flow rate through the recording head 11 can be accurately measured even in a case of performing ink discharge. Therefore, even in a case of performing ink discharge, it is possible to control the flow rate of ink flowing through the recording head 11 to a desired value, and it is possible to discharge ink while continuing the recording operation.

Note that the ink residual quantity detection mechanism is not limited to a weight sensor. For example, a float-type water level meter, an electrostatic liquid surface detection sensor, or the like may be used. It is also possible that, instead of installing the ink residual quantity detection mechanism of the ink tank 21, the amount of ink supplied to the storage tank 22 is measured by the ink residual amount detection mechanism of the storage tank 22 each time of the supply, and the supply amount in each time is accumulated, so as to perform estimation by subtracting the accumulated value from the initial volume. An ink residual quantity detection mechanism may also be installed in the ink tank 21.

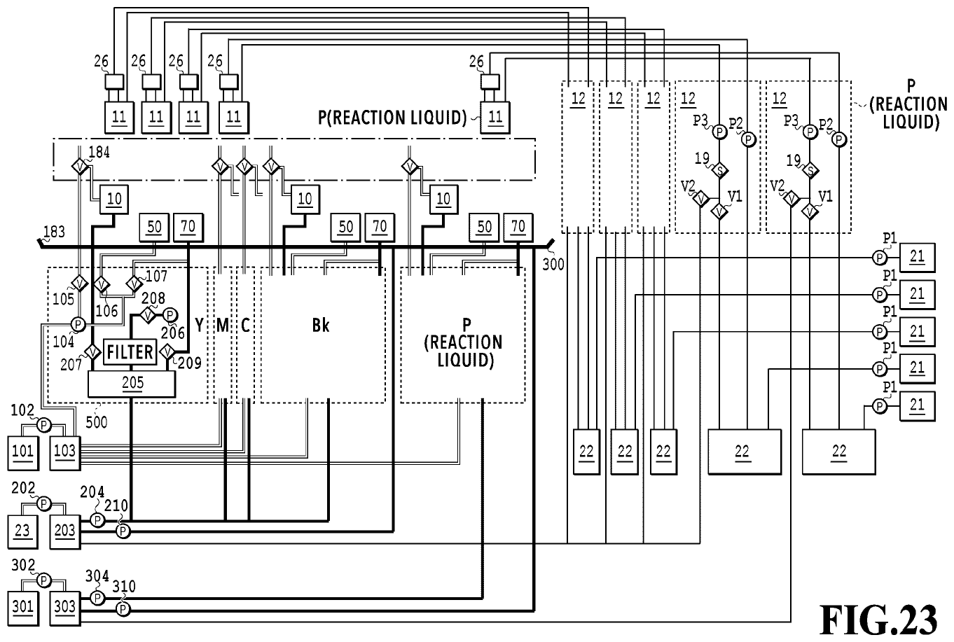

The circulation unit 12 includes the pump P2 (the first liquid moving unit), the pump P3 (the second liquid moving unit), the electrically openable valves V1 and V2, the flow meter 19, etc. The pump P2 pressure-feeds ink from the storage tank 22 to the pressure adjuster 26 (see FIG. 23). The pressure adjuster 26 transfers the supplied ink to the recording head 11 with a pressure difference. The ink on the relatively higher-pressure side is transferred via the pipe 27, and the ink on the relatively lower-pressure side is transferred via the pipe 28.

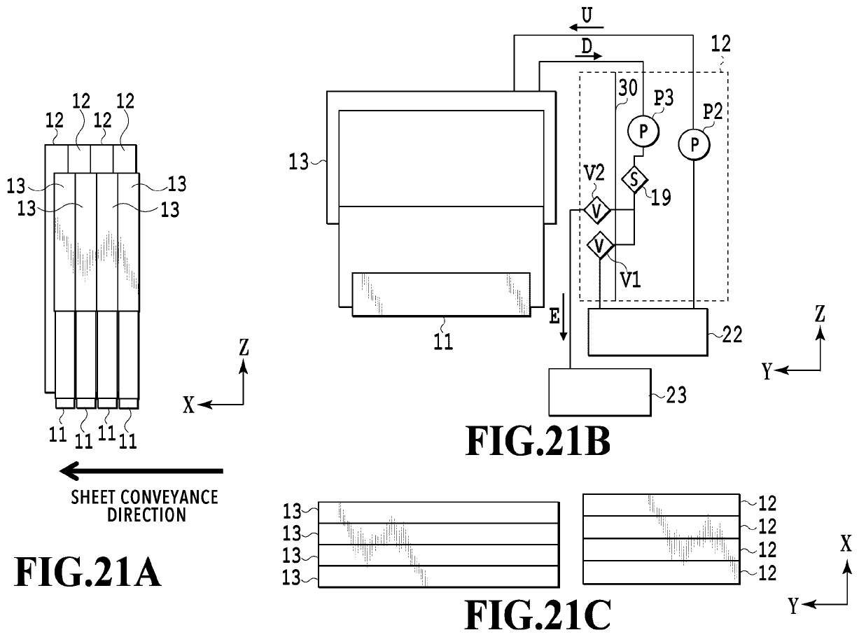

FIGS. 21A to 21C are diagrams schematically illustrating the arrangement of the recording heads 11, the elevating/lowering units 13, and the circulation units 12 corresponding to the respective colors in the present embodiment.

FIGS. 21A to 21C are explanatory diagrams of a circulation unit. As illustrated in FIG. 21A, the circulation units 12 overlap with the projected area of the recording heads 11 in the X direction, i.e., the shorter-width direction, and each constituent element is installed with a reduced unit width in the X direction. As illustrated in FIG. 21B, each constituent element is arranged so as to be aligned in the Y direction and Z direction of the recording heads 11. As a result, the width of the apparatus in the X direction can be downsized.

Furthermore, within the circulation unit 12, the electrically openable valves V1 and V2 and the electrically driven pump P2 and pump P3 are arranged in the regions separated from each other in the Y direction via the partition member 30. As a result, the valves V1 and V2 and the pumps P2 and P3, whose temperatures rise due to electrification during the circulation operation, can be spatially separated. Therefore, even in a downsized space, it is easy to prevent the temperatures of each constituent element, the inside of the circulation unit, and the valves V1 and V2 and the pumps P2 and P3 themselves from rising too high.

The circulation units 12 are each configured as a unit for each corresponding recording head 11, that is, configured as a unit for each color. Therefore, similarly to the recording heads 11 and the elevating/lowering units 13, they can be arranged side by side in the X direction. Therefore, each circulation unit 12 has the same configuration, and thus it is possible to assemble them by preparation of the same parts and in the same assembly procedures, which is efficient. Further, the arrangement in which the lengths of the respective flow paths connecting the circulation units 12 to the recording heads 11 can be the same also improves the case of assembly. In addition, in a case of adding a particular color, it is only necessary to additionally install the recording head 11 and circulation unit 12 corresponding to the particular color, which provides good expandability. Note that the number of colors and the numbers of recording heads 11 and circulation units are not limited to four, and similar effects can still be obtained.

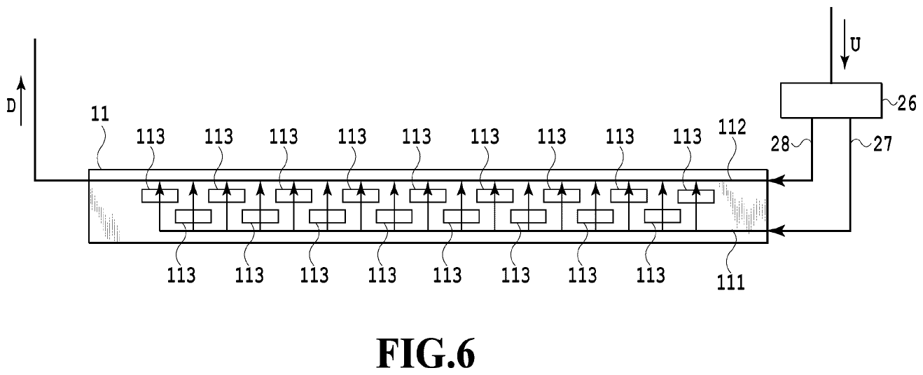

FIG. 6 is a diagram illustrating the flow paths in the recording head 11. The recording head 11 includes the common flow paths 111 and 112. The common flow path 111 is connected to the pipe 27, and is supplied with ink of the high-pressure side. One end of the common flow path 112 is connected to the pipe 28, and is supplied with ink of the low-pressure side. Each individual flow path 113 is connected between the common flow path 111 and the common flow path 112. Ink flows from the common flow path 111 through the individual flow paths 113 to the common flow path 112.

The other end of the common flow path 112 is connected to the downstream flow path. The pump P3 pressure-feeds ink from the common flow path 112 to the storage tank 22. In this manner, ink is circulated between the storage tank 22 and the recording head 11.

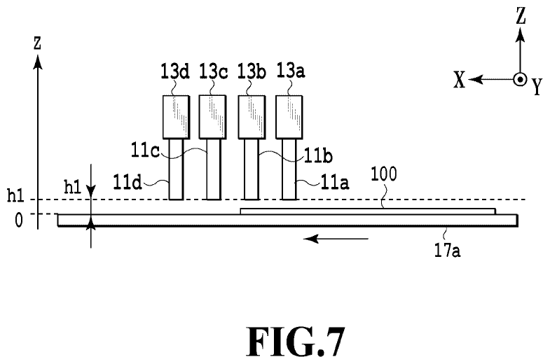

Next, a description is given of the elevating/lowering units 13. FIG. 7 is a diagram illustrating the height of the recording heads 11 during recording. The elevating/lowering units 13 are installed for the respective recording heads 11, and thus the positions of the recording heads 11 in the Z direction can be changed on a per recording head basis. For example, the elevating/lowering unit 13a elevates and lowers the recording head 11a to change its position in the Z direction. Note that, although each recording head 11 can be elevated and lowered individually in the present embodiment, it is also possible that a plurality of recording heads 11 is elevated and lowered by a single elevating/lowering unit 13. In this case, the Z-directional positions of the plurality of recording heads 11 elevated and lowered by the single elevating/lowering unit 13 are changed in common. The elevating/lowering units 13 include, for example, a driving source (not illustrated in the drawings) such as a motor, and an actuator (not illustrated in the drawings) that moves the recording heads 11 by the driving force of the driving source. The actuator is, for example, a ball screw mechanism, a belt driving mechanism, a link mechanism, or the like.

During the recording operation, each recording head 11 is arranged at a position (referred to as the recording position) where the ejection port surface 110 and the surface of the recording medium 100 are spaced apart by the height h1. The height h1 is generally a slight gap (approximately a few millimeters).

### Configuration of the Maintenance Portion

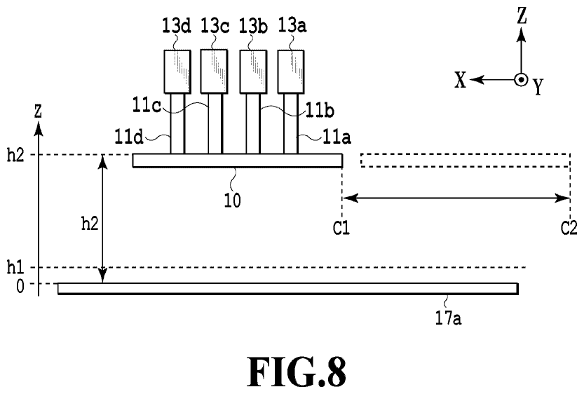

FIG. 8 is a diagram illustrating the capped state of the recording heads 11. During the capping, each recording head 11 is moved by the elevating/lowering unit 13 to the capping position h2 (the height h2). The cap member 10 is moved by a movement mechanism (not illustrated in the drawings) between the capping position C1 where the ejection port surface 110 is covered and the retracted position C2 where the ejection port surface 110 is not covered, as illustrated in FIG. 8. Capping suppresses evaporation of the liquid components of the ink from the ejection ports OP during standby in a non-recording state. Upon receiving a recording command, the cap member 10 moves from the capping position C1 to the retracted position C2, and the capping state is released. Then, the elevating/lowering units 13 are driven to lower the recording heads 11 to the recording position. Then, the conveyance unit 17 starts conveying the recording medium 100. An image is recorded on the recording medium 100 by synchronizing the timings of the recording medium 100 passing under the recording heads 11 with the timings of ink ejection. After the image recording ends, the recording heads 11 are elevated again to the capping position h2, so that capping is performed. Note that, in addition to protecting the ejection port surface 110 of the recording heads 11, the cap member 10 can also perform negative pressure suctioning using a negative pressure suction mechanism.

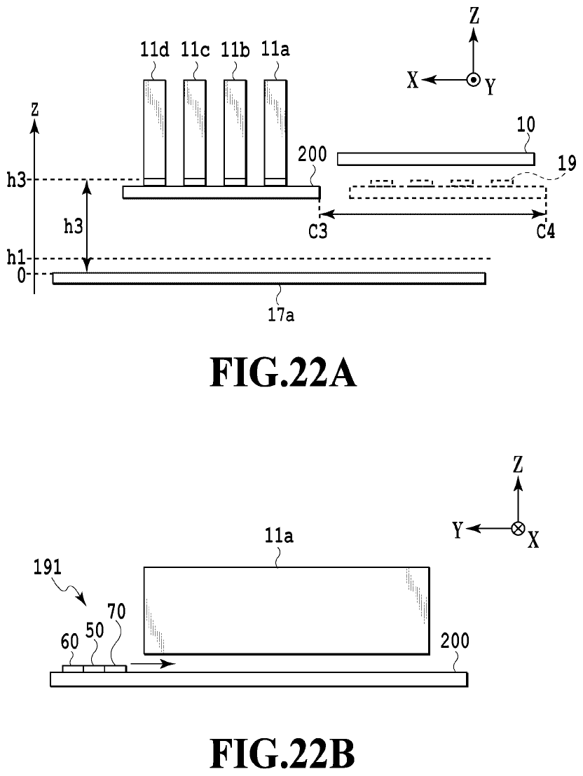

FIG. 22A and FIG. 22B are diagrams describing a cleaning unit. The cleaning tray 200 illustrated in FIG. 22A is equipped with the cleaning mechanism 191 as illustrated in FIG. 22B. Further, the cleaning mechanism 191 also has the cleaning liquid applying portion 50, the liquid removing portion 60, and the negative pressure applying portion 70. The cleaning liquid applying portion 50 applies cleaning liquid onto the ejection port surface 110 of the recording heads 11. The liquid removing portion 60 removes ink, paper dust, or cleaning liquid adhering to the recording heads 11. The negative pressure applying portion 70 applies a negative pressure to the ejection port surface 110 of the recording heads 11 to remove ink that has solidified at nozzle portions or remove bubbles in ink flow paths. This is also referred to as suction cleaning. Further, as illustrated in FIG. 22B, the cleaning tray 200 has a movement mechanism (not illustrated in the drawings) that moves the cleaning mechanism 191 along the wiping direction D, which is orthogonal to the sheet conveyance direction. The cleaning mechanism 191 removes ink and dust from the ejection port surface 110 of the recording heads 11 by combining the cleaning liquid applying portion 50, the liquid removing portion 60, and the negative pressure applying portion 70.

### Configuration of the Flow Paths

Next, with reference to FIG. 23, a description is given about the cleaning liquid supply path, the negative pressure suction flow path, and the waste liquid flow path. The cleaning liquid is transferred from the cleaning liquid pack 101 to the cleaning liquid sub-tank 103 by the pump 102. Furthermore, the liquid can be transferred from the cleaning liquid sub-tank 103 to the cap member 10, the cleaning liquid applying portion 50, and the negative pressure applying portion 70 by the cleaning liquid supply pump 104 installed in the cleaning liquid and negative pressure supply unit 500 (Y, M, C, Bk, P) corresponding to each head. Further, the timing of supplying the cleaning liquid to the cap member 10, the cleaning liquid applying portion 50, and the negative pressure applying portion 70 can be controlled by the respective opening/closing valves 105 to 107.

A negative pressure is applied to the cap member 10 and the negative pressure applying portion 70 by the negative pressure suction pump 206 connected to the negative pressure tank 205. The negative pressure can be applied to each cap member 10 and each negative pressure applying portion 70 through the installed opening/closing valves 207 to 209 via each negative pressure tank.

At the time the negative pressure suctioning is performed by the cap members 10 and the negative pressure applying portions 70, the waste liquid suctioned from the recording heads 11 is transferred from the negative pressure tanks 205 and contained in the sub-tank 203 using the pump 204, and then stored in the waste liquid tank 23 using the pump 202. Further, the collection tray 300 is installed for collecting the cleaning liquid overflowing from the cleaning liquid applying portions 50, so that the overflowing cleaning liquid is transferred to the drain sub-tank 203 by the pump 210. If the capacity of the waste liquid tank 23 gets close to its upper limit, this is detected by the ink residual quantity detection mechanism described above, and the user is prompted to replace the waste liquid tank 23.

Note that, in a case of using the reaction liquid (P), the waste liquid from the head of the reaction liquid (P) is contained in the drain sub-tank 303 for the reaction liquid using the pump 304, separately from the waste liquid flow path from the heads of the color inks (Y to Bk). Furthermore, the waste liquid is stored in the waste liquid tank 301 for the reaction liquid using the pump 302. Therefore, the reaction liquid (P) and the color inks (Y to Bk) do not mix in the waste liquid flow paths, and thus it is possible to prevent the inks from solidifying in the flow paths and causing the flow paths to become clogged.

Note that the waste liquid discharged from the circulation units 12 at the time of ink discharge is also contained in the sub-tank 203 or 303, and is further stored in the waste liquid tank 23 or 301 using the pumps. In this case as well, the waste liquid discharged from the circulation unit 12 of the reaction liquid (P) is stored in the waste liquid tank 301 of the reaction liquid. As described above, the waste liquid from the circulation units 12 merge with the waste liquid flow paths of the maintenance portion, such that both waste liquids are stored in the same sub-tank and waste liquid tank, and thus a configuration with a minimum number of waste liquid tanks is possible.

### Control Unit

FIG. 9 is a block diagram of the control unit 2 of the recording apparatus 1. The control unit 2 includes the printer control portion 900 that controls the recording process. The printer control portion 900 includes the CPU 901 that controls the entire recording apparatus 1, the ROM 902 for storing control programs to be executed by the CPU 901 and various kinds of data, and the RAM 903. The integrated circuit (Application Specific Integrated Circuit: ASIC) 904 includes a built-in network controller, serial IF controller, head data generation controller, motor controller, etc. The head control portion 905 generates final ejection data for controlling the recording heads 11 to perform ejection, generates a driving voltage, controls the recording head elevating/lowering units 13, obtains the head temperatures, and so on.

Further, the control unit 2 includes the communication portion 906 that receives recording jobs including recording data from an external print server or an external PC, the operation control portion 907 that controls an operation panel or the like that accepts user input, and the recording medium conveyance control portion 908 that controls the conveyance of the recording media 100. Further, the control unit 2 includes the circulation control portion 909. The circulation control portion 909 controls the adjustment operation for adjusting the concentrations of solid components in the inks circulated by the circulation units 12. Each control portion includes at least one processor and at least one storage device that stores a program to be executed by the processor. The storage device is, for example, a semiconductor memory.

### Adjustment of the Concentrations of Circulating Inks

As for the inks inside the recording heads 11, the volatile components in each ink evaporate from the ejection ports OP, and the concentration of the solid components in the ink increases. The ink with a high concentration is mixed with the ink in the flow paths and the storage tank 22 through circulation, causing the concentration process in the entire system including the recording heads 11 to progress.

The solid components include, for example, a coloring material (pigment) and or resin. An increase in the concentration of solid components can cause defective ejection. Therefore, an adjustment operation is performed to adjust the concentration of the circulating ink for each type of ink. The adjustment operation in the present embodiment includes an operation of discharging ink from the downstream flow path, and an operation of replenishing ink from the ink tank 21 to the storage tank 22 by driving the pump P1.

By circulating the ink, the concentrated ink in the recording head 11 is dispersed in the circulation flow path and is averaged within the circulation flow path. Therefore, by discharging the ink from the downstream flow path, it is possible to discharge the concentrated ink without discharging ink directly from the nozzles of the head. By replenishing ink after the discharging, the ink in the circulation flow path can be diluted with fresh ink.

A description is given of an example of the processing performed by the control unit 2 in relation to the operation of adjusting the concentration of the solid components. In the present embodiment, the concentration of the solid components is estimated, and the adjustment operation is performed based on the estimation result. These processes can be performed at a predetermined timing based on the passage of time, the amount of recording jobs executed, the amount of ink ejected, and the like. In the following example, a description is given of a case in which these processes are performed each time a recording job is executed, after the recording ends.

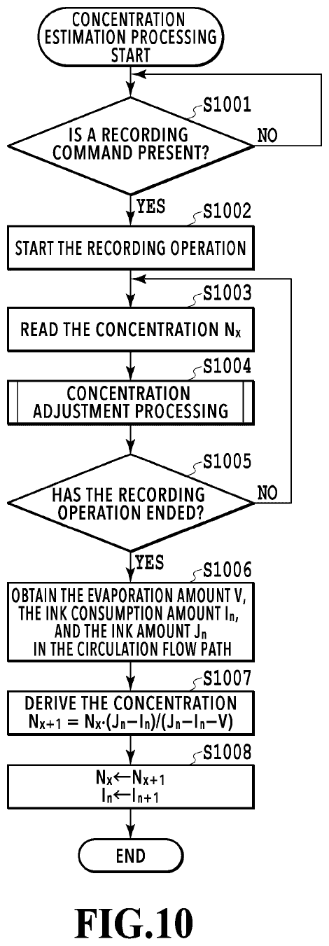

FIG. 10 is a flowchart illustrating an example of the processing for estimating the concentration of a solid component such as a coloring material. The present processing is performed continuously during the time the recording apparatus 1 is running. The present processing is performed by the CPU 901 of the recording apparatus 1 loading a program code stored in the ROM 902 or the like into the RAM 903 and executing it. The concentration of a solid component is estimated for each type of ink (that is, for each recording head), and here, the solid component is assumed to be a pigment. Note that the symbol “S” in the description of each process below indicates that it is a step in the flowchart, and the same applies to the following embodiments. Note that the following explanation describes the processing for one color of ink; however, in practice, the recording apparatus performs recording by ejecting four types of ink, i.e., yellow ink, magenta ink, cyan ink, and black ink, as described above in the present embodiment. That is, each process described below is to be performed appropriately for each ink color in practice.

In S1001, the CPU 901 determines whether or not a command for executing a recording job (a recording command) is present. If it is determined that no recording command is present, the CPU 901 stands by until receiving a recording command. If it is determined that a recording command is present, the CPU 901 proceeds to S1002.

In S1002, the CPU 901 starts the recording operation. In S1003, the CPU 901 reads the current concentration estimated value (the previous estimation result value) Nₓ. The concentration estimated value Nₓ is saved in the RAM 903 and is updated by the later-described concentration adjustment processing or in S1008.

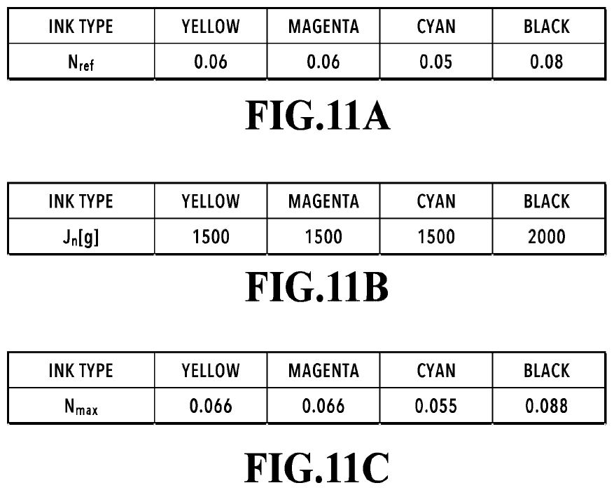

FIGS. 11A to 11C are diagrams illustrating an example of data used in processing. FIG. 11A is a table illustrating a setting example of the initial values N_{ref} as the concentration estimated values Nₓ. The initial values N_{ref} represent the concentration of the pigments in the fresh inks. The present table is saved, for example, in the ROM 902. At the time the power supply of the recording apparatus 1 is turned on for the first time and the circulation flow paths are filled with ink from the ink tanks 21, the concentration estimated values Nₓ are set based on the table of FIG. 11A.

In S1004, the CPU 901 executes the concentration adjustment processing based on the concentration estimated value Nₓ read in S1003. The concentration adjustment processing is for adjusting the concentration of the ink in a circulation flow path to be within a predetermined range. For each time of the concentration adjustment processing, the details of the concentration adjustment processing are described later.

In S1005, the CPU 901 determines whether or not the recording operation has ended. If it is determined that the recording operation has ended, the CPU 901 proceeds to S1006. If it is determined that the recording operation has not ended, the CPU 901 returns to S1003. Thereafter, S1003 to S1005 are repeated while the recording operation continues until it is determined in S1005 that the recording operation has ended.

In S1006, the CPU 901 obtains the evaporation amount V, the ink consumption amount (a cumulative value) Iₙ, and the circulating ink amount Jₙ, which are numerical values necessary for deriving the concentration of ink (for example, the concentration of a coloring material). The circulating ink amount Jₙ is an initial value of the amount of ink in the circulation flow path, and is set in advance based on the specification of the circulation flow path. FIG. 11B illustrates an example of the circulating ink amounts. The ink consumption amount Iₙ is a cumulative value of the amount of ink that has been ejected in the recording operations up to now, and mainly depends on the contents of the recording operations in each recording job. The amount of ink ejected in a recording operation is calculated, for example, from a count value of the pixel count in a recorded image corresponding to the type of ink. For example, this can be obtained by multiplying the count value by the ejection amount of one ejection (for example, 2.0 [ng]). By adding the ink consumption amount in the current recording operation I_{c}, Iₙ₊₁ is calculated as Formula (1).

Iₙ₊₁=Iₙ+I_{c} Formula (1)

In S1007, the CPU 901 derives a concentration estimated value of the ink. The current concentration estimated value Nₓ₊₁ is calculated as Formula (2).

Nₓ₊₁=Nₓ·(Jₙ−Iₙ)/(Jₙ−Iₙ−V) Formula (2)

In S1008, the CPU 901 updates the concentration estimated value and the ink consumption amount to the currently derived values. Thereafter, the CPU 901 returns the processing of the present flowchart to S1001.

Note that, as for the evaporation amount V obtained in S1006 of FIG. 10, the ink evaporation speed at the ejection ports OP is set, and the evaporation amount V is calculated from the set evaporation speed.

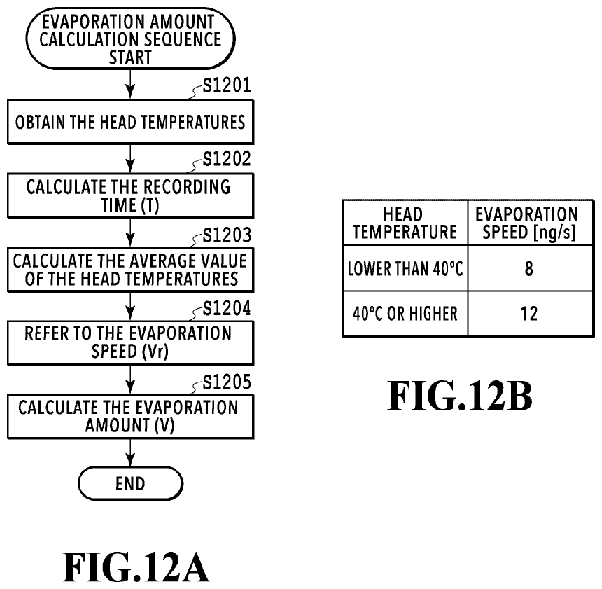

FIGS. 12A and 12B are flowcharts illustrating an example of processing executed by the control unit, and an evaporation speed table. FIG. 12A illustrates an obtaining flow of the evaporation amount V, which is obtained in S1006 of FIG. 10. The processing of the present flowchart is performed, for example, in the process of S1006 in FIG. 10. In S1201, the CPU 901 causes the head control portion 905 to obtain the temperatures of the temperature sensors SR of the head. Here, the temperatures are sampled every 100 milliseconds for each HB.

In S1202, the CPU 901 derives the recording time T. The recording time T is the time period (seconds) from the point in time where a recording command is received and the cap is opened (the time T0) up to the point in time where the capping is completed again (the time T1), which is after the recording head 11 lowers from the capping position to the recording position at the height h1 and the recording operation ends (T=T1−T0). This recording time T can be derived by measurement.

In S1203, the CPU 901 derives the average value of temperature during the recording time T, and further derives the average value of the 17 HBs.

In S1204, the CPU 901 refers to the table saved in advance in the ROM 902, and obtains the evaporation speed Vᵣ corresponding to the head temperature obtained in S1203. FIG. 12B illustrates an example of the table to which the CPU 901 refers in S1204. As illustrated in FIG. 12B, the evaporation speed Vᵣ is a speed per one ejection port OP and is specified in units of [ng/s].

In S1205, the CPU 901 derives the evaporation amount V [g/sec]. In the present embodiment, the evaporation amount V is derived by Formula (3).

V=Vᵣ·T·N Formula (3)

Note that N is the number of ejection ports OP. For example, in each of the heater boards HB0 to HB16, if three are 2048 (512×4 arrays) ejection ports OP, then the total number of ejection ports OP per recording head 11 is 34816. The evaporation amount is calculated as described above, and the evaporation amount obtaining sequence ends.

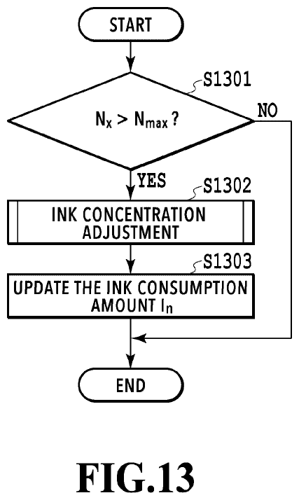

FIG. 13 is a flowchart for describing each step in the ink concentration adjustment processing executed in S1004 of FIG. 10.

In S1301, the CPU 901 determines whether the concentration estimated value Nₓ exceeds the predetermined upper limit value Nₘₐₓ (a predetermined concentration). FIG. 11C illustrates an example of the upper limit values Nₘₐₓ. The upper limit value Nₘₐₓ are set for the respective ink types, and are saved in the ROM 902. If it is determined that the concentration estimated value Nₓ exceeds the upper limit value Nₘₐₓ, the CPU 901 proceeds to S1302. If it is determined that the concentration estimated value Nₓ does not exceed the upper limit value Nₘₐₓ, the CPU 901 ends the processing of the present flowchart.

In S1302, the CPU 901 causes the circulation control portion 909 to execute the ink concentration adjustment. The adjustment includes the operation of discharging ink from the downstream flow path as described above. At that time, the discharged amount of ink may be increased as the concentration estimated value Nₓ increases. The details of S1302 are described later.

In S1303, the ink consumption amount Iₙ is increased by the discharge amount of ink discharged in S1302. After that, the CPU 901 ends the processing of the present flowchart.

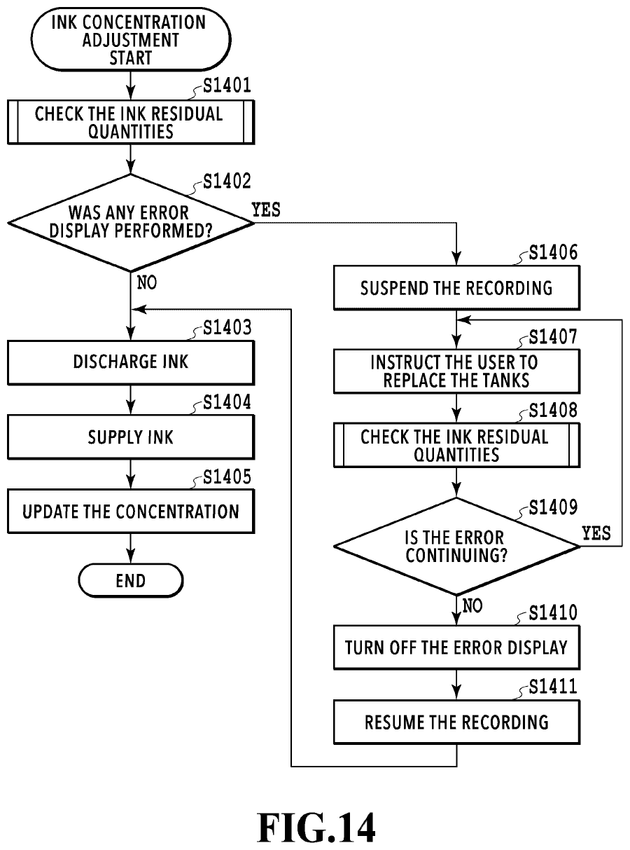

FIG. 14 is a detailed flowchart of the ink concentration adjustment in S1302 of FIG. 13. In S1401, the CPU 901 checks the ink residual quantities.

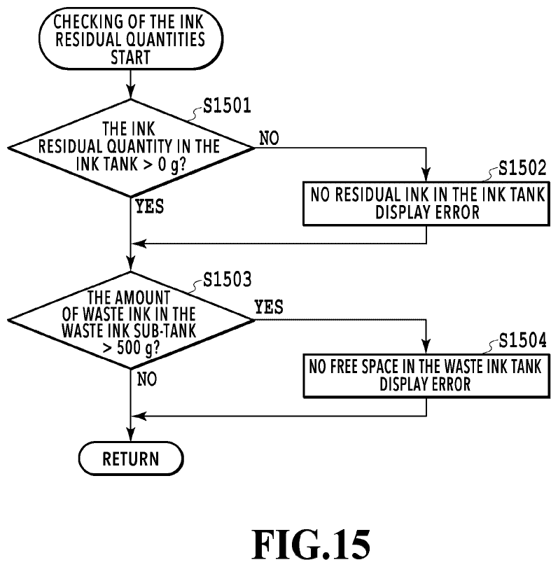

FIG. 15 is a flowchart for checking the ink residual quantities. That is, this is the detailed processing of S1401 in FIG. 14. In S1501, the CPU 901 determines whether or not the residual quantity in the ink tank 21 is greater than a predetermined threshold value. In the present embodiment, the predetermined amount (the threshold value) of the residual quantity in the ink tank 21 is assumed to be 0 g. A low residual quantity in the ink tank 21 indicates that there is not enough ink to be used for recording. Therefore, in a case where the residual quantity in the ink tank 21 becomes equal to or lower than the predetermined amount (equal to or lower than the threshold value), an error is displayed to prompt replacement of the ink tank 21. If it is determined that the ink residual quantity in the ink tank 21 is greater than 0 g, the CPU 901 proceeds to S1503. If it is determined that the ink residual quantity in the ink tank 21 is 0 g, the CPU 901 proceeds to S1502.

In S1502, the CPU 901 displays, on the operation control portion 907, an error indicating that there is no residual ink in the ink tank.

In S1503, the CPU 901 determines whether the amount of ink in the waste liquid tank 23 exceeds a predetermined amount. In the present embodiment, the predetermined amount of waste ink in the waste liquid tank 23 is assumed to be 500 g. In a case where the amount of waste ink in the waste liquid tank 23 exceeds the predetermined amount, the waste liquid tank 23 must be emptied of waste ink. Therefore, in a case where the amount of waste ink in the waste liquid tank 23 exceeds the predetermined amount, an error is displayed. If it is determined that the ink residual quantity in the waste liquid tank 23 is greater than 500 g, the CPU 901 proceeds to S1504. If it is determined that the ink residual quantity in the waste liquid tank 23 is equal to or lower than 500 g, the CPU 901 ends the processing of the present flowchart. In S1504, the CPU 901 displays, on the panel of the operation control portion 907, an error indicating that there is no free space in the waste liquid tank 23. The above is the detailed processing of S1401 in FIG. 14.

Returning to FIG. 14, the explanation is continued. In S1402, the CPU 901 determines whether the error display has been performed for either the ink tank 21 or the waste liquid tank 23 in the processing of FIG. 15.

If it is determined that at least one of the error displays has been performed, the CPU 901 proceeds to S1406. If it is determined that no error display has been performed for any of them, the CPU 901 proceeds to S1403.

In S1403, the CPU 901 causes the circulation control portion 909 to execute the ink discharging operation. For the ink discharging operation, the method described in FIG. 5 is used. That is, the CPU 901 opens the valve V2 and then closes the valve V1 while causing the circulation control portion 909 to control the pumps P1 to P3. Further, if the discharge amount reaches a predetermined amount after the valve V2 is opened, the valve V1 is opened and the valve V2 is closed, so as to complete the discharge operation. In S1404, the CPU 901 supplies ink from the ink tank 21 to the storage tank 22. In S1405, the CPU 901 updates the concentration estimated value Nₓ, and ends the processing of the present flowchart.

In S1406, the CPU 901 suspends the recording. Note that, in the present processing, the recording is to be suspended in a case where an error is detected in S1402 in any one of the ink colors practically used by the recording apparatus. In S1407, the CPU 901 issues an instructing for replacement of the ink tank 21 or the waste liquid tank 23 depending on the content of the error. This is displayed on the panel of the operation control portion 907.

In S1408, the CPU 901 checks the ink residual quantities again. Specifically, the same process as in S1401 is carried out. In S1409, the CPU 901 determines whether the ink in the ink tank 21 exceeds the predetermined amount and the waste ink in the waste liquid tank 23 is equal to or lower than the predetermined amount. If it is determined that the ink in the ink tank 21 is equal to or lower than the predetermined amount, or if the waste ink in the waste liquid tank 23 exceeds the predetermined amount, or if both conditions are met, the CPU 901 returns to S1407. If it is determined that the ink in the ink tank 21 exceeds the predetermined amount and the waste ink in the waste liquid tank 23 is equal to or less than the predetermined amount, the CPU 901 proceeds to S1410.

In S1410, the CPU 901 turns off the error displayed on the panel of the operation control portion 907 in S1401. In S1411, the CPU 901 resumes the recording, and proceeds to S1403. Thereafter, the same process as described above is carried out in S1403.

In this way, with such a configuration that allows ink to be discharged from the downstream flow path, the discharge operation can be executed at any time based on the concentration calculated values while executing recording. As a result, it is possible to reduce downtime in recording which is caused by the configuration in which discharging is performed directly from the head and thus can only be performed during non-recording operations.

As described above, according to the present embodiment, it is possible to reduce downtime caused by ink discharge. In particular, the configuration with such a circulation flow path and discharge flow path as illustrated in FIG. 5 enables the discharge operation of waste ink in parallel with the recording operation and the circulating operation. That is, since the ink discharge operation by capping is not performed, the recording operation can be continued. Further, since the discharge operation is performed at an appropriate timing for each ink, the ejection state of all inks can be preferably maintained.

### Second Embodiment

In the first embodiment, a description is given about the processing of suspending recording in a case where the residual quantity in an ink tank is insufficient before execution of discharging or supplying. In the present embodiment, the ink residual quantity in the ink tank 21 is constantly monitored, and if the residual quantity is getting close to the predetermined amount (the threshold value for determining the presence or absence of the residual quantity in FIG. 15), a warning stating “The ink residual quantity is low.” is displayed on the panel of the operation control portion 907 to prompt replacement of the ink tank 21. The warning is displayed in real time on the panel of the operation control portion 907. For example, among the ink tanks 21 of the four colors, if there is any ink whose residual quantity has decreased to 300 g, the warning is issued. Further, regarding the waste liquid tank 23, if the amount of waste ink reaches 400 g, a warning is issued. This makes it possible to prevent recording from being suspended due to an insufficient residual quantity at the time ink concentration adjustment is triggered.

Note that, in a case where the ink concentration is not close to the upper limit value Nₘₐₓ, a warning with reference to the concentration estimated value in addition to the ink residual quantity may also be issued. For example, only in a case where the concentration estimated value has reached 70% of Nₘₐₓ and, in addition, the residual quantity has been close to the predetermined amount (the threshold value for determining the presence or absence of the residual quantity in FIG. 15), the warning stating “The ink residual quantity is low.” may be issued to prompt replacement of the tank.

### Third Embodiment

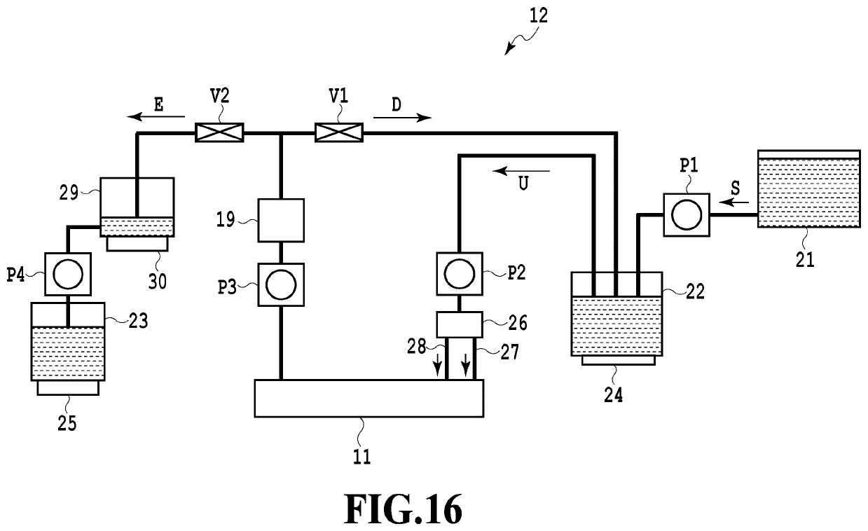

In the first embodiment, a description is given of the configuration in which the waste liquid tank is directly connected to the branching flow passage. In the present embodiment, a description is given of a configuration in which a waste liquid sub-tank is connected between the branch portion and the waste liquid tank. FIG. 16 illustrates a circulation unit employed in the present embodiment. The ink discharged from the branch portion is first contained in the waste liquid sub-tank 29, and is transferred sequentially to the waste liquid tank 23 using the pump P4. Therefore, the waste liquid sub-tank 29 usually has a sufficient amount of space (is almost empty). In a case where the amount of waste ink in the waste liquid tank 23 is full, the transferring of liquid from the waste liquid sub-tank is stopped. Therefore, after the waste liquid tank 23 becomes full, the free space in the waste liquid sub-tank 29 may become small. The waste liquid sub-tank 29 is equipped the sensor 30 for measuring the amount of waste ink contained therein.

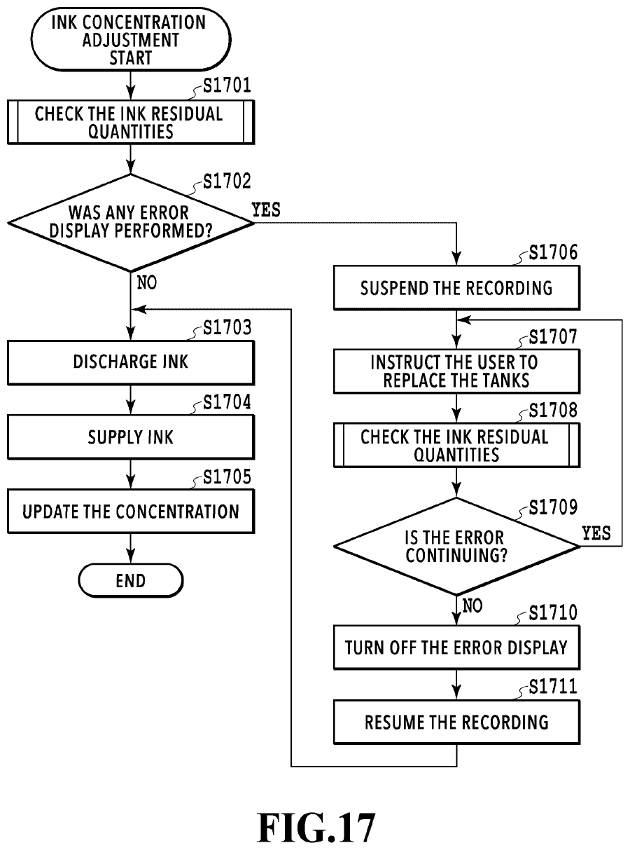

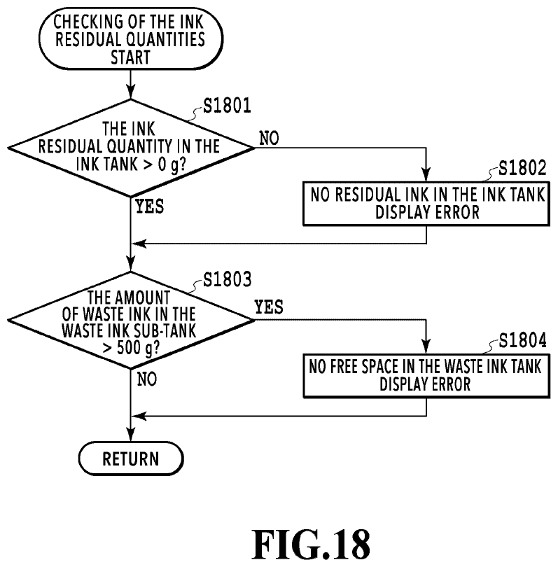

In the first embodiment, the amount of waste ink in the “waste liquid tank” is checked in the flowcharts of FIG. 14 and FIG. 15, but in the present embodiment, the amount of waste ink in the “waste liquid sub-tank” is checked. A description is given of the processing flows with reference to FIG. 17 and FIG. 18. Note that the description of the processes described in the first embodiment is omitted.

FIG. 17 is a flowchart of the ink concentration adjustment in the present embodiment. Further, FIG. 18 is a flowchart for checking the ink residual quantities. In S1701, the CPU 901 checks the ink residual quantities. Specifically, the processing of FIG. 18 is carried out. In S1803, the CPU 901 determines whether or not the amount of waste ink in the waste liquid sub-tank 29 exceeds a predetermined amount. In a case where the amount of waste ink in the waste liquid sub-tank 29 exceeds the predetermined amount, it indicates that the waste liquid tank 23 is full. The CPU 901 proceeds to S1804 and displays an error indicating that there is no free space in the waste liquid tank. The display is performed on the panel of the operation control portion 907.

Returning to FIG. 17, in S1702, the CPU 901 determines whether an error has been displayed for the residual quantity in the ink tank 21 and the waste ink in the waste liquid tank 23. If it is determined that an error has been displayed for the residual quantity in the ink tank 21 and the waste ink in the waste liquid tank 23, the CPU 901 proceeds to S1706.

After issuing an instruction for replacing the tanks in S1707, the CPU 901 performs the processing of checking the ink residual quantities again in S1708. That is, the processing of FIG. 18 is carried out. In S1709, the CPU 901 determines whether the ink in the ink tank 21 exceeds the predetermined amount and the waste ink in the waste liquid sub-tank 29 is equal to or lower than the predetermined amount. If it is determined that the ink in the ink tank 21 exceeds the predetermined amount and the waste ink in the waste liquid sub-tank 29 is equal to or lower than the predetermined amount, the CPU 901 proceeds to S1710. In S1710, the CPU 901 turns off the error displayed in the processing of FIG. 18. Thereafter, the same processing as that described with reference to FIG. 14 is carried out.

With this configuration, even in a state where the waste liquid tank has no free space (is full) or the waste liquid tank is removed, if there is free space in the waste liquid sub-tank, ink can be discharged from the circulation flow path. Note that the present embodiment may be appropriately combined with the second embodiment. Specifically, in the processing of FIG. 18, for example, in a case where the residual quantity in the ink tank has decreased to 300 g, a warning may be displayed on the operation control portion 907. Further, in a case where the amount of waste ink in the waste liquid sub-tank 29 has reached 400 g, a warning indicating that there is no free space in the waste liquid tank 23 is displayed. By providing the user of warnings prior to the error display, the user can replace the ink tank, the waste liquid tank, or the waste liquid sub-tank without suspending recording.

### Fourth Embodiment

In the first embodiment, a description is given of the configuration in which a branch is formed in the downstream flow path to discharge ink, but it is also possible to employ a configuration in which the ink is discharged directly from the storage tank 22.

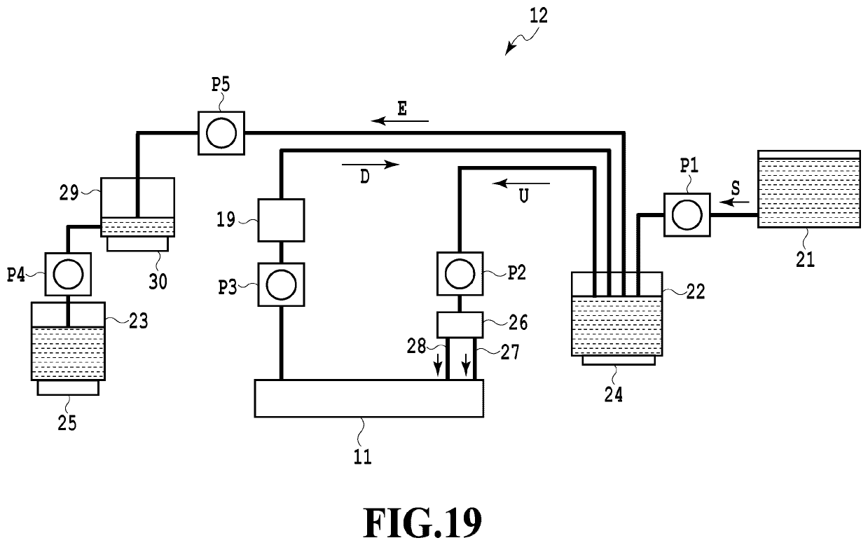

FIG. 19 is a diagram illustrating the circulation unit 12 of the present embodiment. Such a branch portion as in the previous embodiment is not formed, and the storage tank 22 and the waste liquid sub-tank 29 are connected via the pump P5.

According to the configuration of the present embodiment, at the time of executing the ink discharge, it is possible to drive the pump P5 to directly transfer ink from the storage tank 22 to the waste liquid sub-tank 29.

### Fifth Embodiment

In the first embodiment, as the ink concentration adjustment, the method in which whether or not the adjustment operation needs to be executed is determined based on a concentration value; however, it is also possible to install a sensor that measures the concentration, so that the determination is made based on a detection result. As the sensor, a sensor that measures the refractive index of a liquid or a sensor that measures an electric resistance value may be installed in the ink circulation flow path. If the ink composition changes due to a change in concentration, the refractive index and electric resistance value change, and thus, by measuring the relationship between its characteristic value and concentration in advance, it is possible to set a threshold value for determining the need for execution.

Alternatively, a viscometer capable of measuring the viscosity of an ink, not the concentration, may be used. In this case, the need for executing the adjustment operation may be determined based on the viscosity value itself.

It is also possible that such estimation or detection of the concentration is not performed, and the discharging is performed at a preset fixed time interval.

### Sixth Embodiment

In the above-described first to fifth embodiments, a full-line type head is exemplified as the recording head 11, but an application to a serial type recording apparatus is also possible.

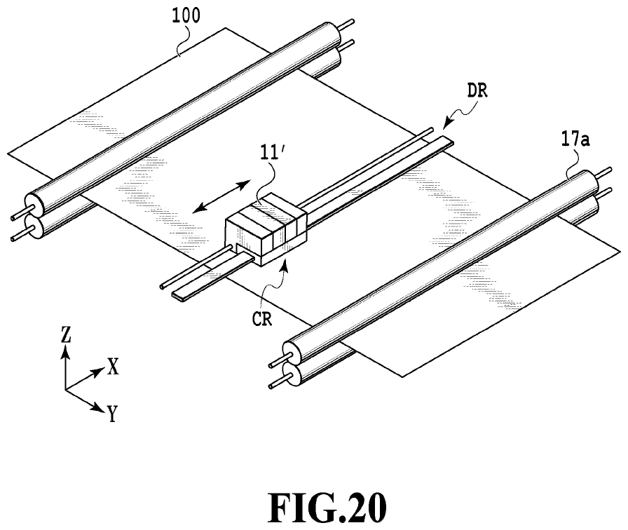

FIG. 20 is a schematic diagram illustrating an example of a serial type recording apparatus. A plurality of recording heads 11′ is mounted on the carriage CR, and the carriage CR is reciprocated by the scanning mechanism DR in the direction across the recording medium 100 (the X direction).

The scanning mechanism DR is, for example, a belt driving mechanism, and includes a pair of pulleys spaced apart in the X direction, an endless belt wound around the pair of pulleys, and a motor that rotates the pulleys. The carriage CR is fixed to the endless belt, and moves by driving the endless belt using the motor. The scanning mechanism DR is an example of a movement mechanism that moves the recording heads 11′ and the recording medium 100 relative to each other.

### OTHER EMBODIMENTS

The above embodiments are described as processing that is performed in a case where the ink concentration becomes thicker than a predetermined threshold value, but an application to cases where the ink concentration becomes thinner is also possible. For example, in a circulation unit containing white ink, an application to an ink discharge operation that is performed in a case where the ink concentration becomes thinner due to sedimentation is also possible.

Although the case of using inks as coloring materials is described in the above embodiments, the coloring materials may be pigments or dyes.

As described above, according to the present disclosure, it is possible to reduce downtime caused by ink discharge.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Applications No. 2024-141944, filed Aug. 23, 2024, and No. 2025-066891, filed Apr. 15, 2025, which are hereby incorporated by reference herein in their entirety.

What is claimed is:

1. A recording apparatus comprising:
a recording head configured to eject ink;
a storage tank configured to store the ink to be supplied to the recording head;
a first flow path through which the ink flows from the storage tank to the recording head;
a second flow path through which the ink coming out of the recording head flows;
a discharge flow path branched from a circulation flow path, which is configured with the first flow path and the second flow path and through which the ink is circulated;
a waste liquid tank configured to store liquid discharged from the circulation flow path through the discharge flow path;
a discharge unit configured to discharge the ink from the circulation flow path to the waste liquid tank; and
at least one memory and at least one processor which function as a control unit configured to control a recording operation performed by the recording head and a discharge operation performed by the discharge unit,
wherein the control unit causes the discharge unit to perform the discharge operation during the recording operation of the recording head.

2. The recording apparatus according to claim 1,
wherein, in a case where a concentration of the ink in the circulation flow path becomes higher than a predetermined threshold value, the control unit causes the discharge unit to perform the discharge operation during the recording operation of the recording head.

3. The recording apparatus according to claim 1,
wherein, in a case where an amount of free space in the waste liquid tank is equal to or lower than a first threshold value, the control unit causes the recording head to suspend the recording operation and notifies a user that the waste liquid tank needs to be replaced.

4. The recording apparatus according to claim 1,
wherein, in a case where a residual quantity in an ink tank that replenishes the storage tank with ink is equal to or lower than a second threshold value, the control unit causes the recording head to suspend the recording operation and notifies a user that the ink tank needs to be replaced.

5. The recording apparatus according to claim 3,
wherein, in a case where the amount of free space in the waste liquid tank becomes equal to or lower than a third threshold value which is greater than the first threshold value, the control unit does not suspend the recording and issues a warning indicating that the amount of free space is low.

6. The recording apparatus according to claim 4,
wherein, in a case where the residual quantity in the ink tank becomes equal to or lower than a fourth threshold value which is greater than the second threshold value, the control unit does not suspend recording and issues a warning indicating that the residual quantity in the ink tank is low.

7. The recording apparatus according to claim 1,
wherein the discharge unit discharges the ink from the circulation flow path to the waste liquid tank via a discharge flow path connecting the circulation flow path, through which the ink flows from the recording head to the storage tank, and the waste liquid tank.

8. The recording apparatus according to claim 1,
wherein the discharge unit discharges the ink from the circulation flow path to the waste liquid tank via a discharge flow path connecting the storage tank and the waste liquid tank.

9. The recording apparatus according to claim 1,
wherein the discharge unit includes a waste liquid sub-tank arranged between the waste liquid tank and the circulation flow path, and a liquid transfer unit configured to transfer the liquid from the waste liquid sub-tank to the waste liquid tank, and
wherein, in a case where the waste liquid tank has no free space, the control unit stops the liquid transfer unit while continuing the recording operation performed by the recording head.

10. The recording apparatus according to claim 9,
wherein, in a case where the amount of free space in the waste liquid sub-tank becomes equal to or lower than a fifth threshold value, the control unit causes the recording head to suspend the recording operation and notifies a user that the waste liquid tank needs to be replaced.

11. The recording apparatus according to claim 1,
wherein a concentration of the ink in the circulation flow path is derived based on an ink consumption amount, an evaporation amount, and an ink amount in the circulation flow path.

12. The recording apparatus according to claim 1,
wherein a concentration of the ink in the circulation flow path is measured by a sensor installed in the circulation flow path.

13. The recording apparatus according to claim 1,
wherein the recording head is of a serial type or a full-line type.

14. The recording apparatus according to claim 1,
wherein the circulation flow path through which the ink flows from the recording head to the storage tank further comprises:
a detection unit configured to detect a flow rate; and
a branch portion leading to the discharge flow path connected to the waste liquid tank, and
wherein the detection unit is installed on a recording head side relative to the branch portion.

15. The recording apparatus according to claim 1 further comprising
a negative pressure applying portion configured to be capable of performing suction cleaning in a state of facing an ejection port surface of the recording head,
wherein a discharge flow path from the negative pressure applying portion is connected to the waste liquid tank.

16. The recording apparatus according to claim 1 further comprising
a circulation unit including:
a first liquid moving unit configured to supply liquid to the recording head;
a second liquid moving unit configured to discharge the liquid that has circulated through the recording head to the outside of the recording head;
a switching unit configured to be capable of switching flow paths to perform the discharge operation; and
a partition member,
wherein the circulation unit includes a first region and a second region partitioned by the partition member,
wherein the first liquid moving unit and the second liquid moving unit are arranged in the first region, and
wherein the switching unit is arranged in the second region.

17. The recording apparatus according to claim 16 further comprising
an elevating/lowering unit configured to elevate and lower the recording head,
wherein the circulation unit overlaps with a projected area of the elevating/lowering unit.

18. The recording apparatus according to claim 1, wherein the discharge flow path is a flow path branched from the second flow path.

19. A control method for a recording apparatus including
a recording head configured to eject ink;
a storage tank configured to store the ink to be supplied to the recording head;
a first flow path through which the ink flows from the storage tank to the recording head;
a second flow path through which the ink coming out of the recording head flows;
a discharge flow path branched from a circulation flow path, which is configured with the first flow path and the second flow path and through which the ink is circulated;
a waste liquid tank configured to store liquid discharged from the circulation flow path through the discharge flow path;
a discharge unit configured to discharge the ink from the circulation flow path to the waste liquid tank; and
at least one memory and at least one processor which function as a control unit configured to control a recording operation performed by the recording head and a discharge operation performed by the discharge unit,
wherein the control unit causes the discharge unit to perform the discharge operation during the recording operation of the recording head.
